(19) United States
(12) Patent Application Publication
(10) Pub. No.: US 2005/0036852 A1
(43) Pub. Date: Feb. 17, 2005

(54) Fastener with key way and locking piece

(76) Inventor: Jim J. Berna, Visalia, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 10/640,170

(22) Filed: Aug. 12, 2003

(51) Int. Cl. F16B 15/00

(52) U.S. Cl. 411/447

(57) ABSTRACT

A two-piece locking fastener which includes a first shaft having a head with a chamfered opening leading into a key way which extends part way down one side of the shaft having an outward taper towards the bottom of the key way. A second shaft is also provided which fits into said vertical key way, preferably having a tapered blunt end at the bottom, which corresponds to the tapered bottom of the key way of the first shaft. Both the key way and the second shaft are specially shaped for proper orientation of the second shaft within the key way. After the first shaft is driven into a medium, the second shaft (which is longer than the groove) is inserted into the key way and then driven downward such that the bottom of the second shaft protrudes outward into the medium at a different angle than the first shaft. One or more friction wedges on the sides of the second shaft cut into the sides of the vertical key way as the second shaft is driven downward, causing firm interengagement between the second shaft and the vertical groove. This interaction helps lock the two shafts together and firmly in place in the medium. Several alternative embodiments are available including rounded and squared spikes, nails, and screws.

### BACKGROUND OF THE INVENTION

1 . Field of the Invention

The present invention relates to fasteners and more particularly to a modified two-piece fastener with key way and locking piece for use in a spike, screw or nail system for providing improved holding ability when subjected to regular and/or extreme vibrations or stresses.

2. Description of the Prior Art

Railroad spikes, railroad screw spikes, bridge spikes, and other nails are well known within their respective industries. The general function of these various devices is to firmly hold different mediums together. Railroad spikes are used to hold steel rails and tie plates against wooden railroad ties; railroad screw spikes are used to hold steel rails and tie plates to railroad ties at intersections; longer anchor screws or spikes are used to hold multiple railroad ties together; bridge spikes are used to hold wooden piers or bridge tresles together; and nails are used for unlimited connective purposes.

In the example of the railroad spike, trains passing over a spike cause heavy vibrations with repeated compression and decompression of the rails and ties, which eventually loosens the spike, rails, tie plates and/or ties. This can cause widening of the rail gauge resulting in the derailment of a passing train. Train derailments are serious and may result in damage to railroad assets, with the loss of property and freight, including but not limited to, the release of hazardous materials, and the potential loss of human life. In an attempt to prevent the possibility of disastrous derailments or accidents from unstable tracks, railroad companies expend enormous amounts of time, money and resources in on-going inspections, resulting in replacing or attempting to tighten the spikes.

Similarly, wooden bridges, piers and docks are held together with specially designed spikes. Over time, changes in weather, temperature, pressure, as well as constant use and buffeting also result in the loosening of these spikes from the medium, causing the bridge, pier, dock or other structure to become unstable. In fact, in almost any connective situation involving a spike, screw or nail, over time the various stresses and pressures applied to the connected mediums can result in the loosening and diminishment of the connection.

A variety of devices have been invented attempting to address these problems:

U.S. Pat. No. 82,900 discloses a spike and key combination. The spike contains an inclined or curved hole from one side of the spike to the other, with a vertical guide-groove along one side from the head of the spike to the hole upon that side. The spike is driven into the medium. The key is then also driven directly into the medium against the guide-groove of the spike. While within the medium, the key enters the spike through the inclined hole and exits at an angle through the other side, forming a locking mechanism within the medium.

U.S. Pat. No. 971,308 discloses a slightly curved spike utilizing upwardly and outwardly inclined teeth along the sides of the spike. The teeth provide a hooking feature that makes the spike difficult to dislodge once it is inserted into the medium. The slight curvature of the spike provides additional placement support for the teeth by grasping the walls of the hole when the spike is subject to heavy vibrations.

U.S. Patent No. 5,429,300, also by the inventor of the present invention, discloses another spike and key combination. The spike contains a vertical groove cut into one side, extending from the spike head down to approximately one third the length of the shaft, and tapered at the lower end in an outwardly direction. The spike is driven into the medium. The key is then driven down the vertical groove within the spike, and bent outward by the lower end taper to form a locking mechanism.

However, each of these inventions has its drawbacks. For example, the diameter of the hole created by inserting a U.S. Pat. No. 971,308 spike into a medium equals the diameter of the spike itself. Though the slight curvature and angled teeth allows the spike to grip the walls of the hole, constant heavy vibrations will cause the spike to move in all directions and ultimately force it to dislodge its grip. The other inventions, utilizing angularly directed keys within the medium, fare little better; the vibrations and omnidirectional movement of the spikes and keys will ultimately cause the keys to dislodge from the spike hole or groove.

The curvature of the U.S. Pat. No. 971,308 spike presents an additional problem, in that such curvature increases the difficulty of driving the spike into the medium. Specifically, the force necessary to drive the spike into the medium must be exerted directly downward. However, the curvature of the spike deflects the force in the concave direction, possibly causing the spike to slip to the opposite direction and resulting in injury.

Additional problems exist with the U.S. Pat. No. 82,900 spike and key. First, the key is driven separately into the medium along an external vertical groove. The key may not be aligned properly to the angular hole within the spike, causing the key to miss the hole entirely and thus negating any angular support for the spike within the medium. Since the alignment occurs within the medium, it is difficult to determine whether the spike and key are properly aligned. Furthermore, the angular hole traverses the entire width of the spike. This particular design weakens the structural integrity of the spike, and increases the likelihood that heavy vibrations will cause the spike to bend or break within the medium at that particular width.

### SUMMARY OF THE INVENTION

It is therefore the most important object of the present invention to provide an improved two-piece fastener, spike, screw or nail system having a key way and locking piece that provides substantial connective stability when installed into wooden ties or other similar media. The invention is a safety device that helps prevent rail rollover, wide gauge, loose spikes, and which solves other various problems within the railroad industry.

It is another important object of the present invention to provide a two-piece fastener, spike, screw or nail system including a first shaft that provides significant downward connection from the shaft of a fastener, spike, screw or nail; beveled/countersink chamfers for greater alignment; and improved connective and stabilizing characteristics associated with a second shaft having frictional joining wedges.

It is another important object of the present invention to provide a two-piece fastener, spike, screw or nail system that is not easily dislodged when subject to heavy vibrations, lateral forces, rail rollover, weathering effects, hot/cold temperatures, repeated rail compression/decompression caused by expansion/contraction of the rails and wooden ties of said medium as trains pass over, thereby avoiding widening of the rail gauge which can otherwise result in the derailment of a passing train.

It is a further object of the present invention to provide a three-piece fastener system for holding media together that includes a first piece made up of a shaft member with a head designed to be driven into a medium, the head having a chamfered opening leading into a key way which extends part way down one side of the shaft and has an outward taper towards the bottom; a second piece in the form of a smaller shaft having at least one frictional wedge along one or more sides for cutting into the key way and frictionally connecting with the first piece such that the smaller shaft extends out from the first shaft and into the medium when fully driven into the key way; and a third optional piece in the form of a plate member having an opening with the same cross section as the first shaft for receiving this shaft and thereafter becoming frictionally attached to it through the driving of the second shaft into the key way.

The present invention satisfies these objectives by providing a main fastener in the form of a spike, screw or nail having a shaft with a round, square or rectangular cross section, a point at one end and a head at the opposite end. A vertical slot or groove (“key way”) is provided along part of one side of the shaft leading to an opening at the head. The opening at the head includes one or more beveled/countersink chamfers that help center and align a second shaft in the form of a directional key that fits into the key way.

The key way is open at the top (i.e. on the head) of the fastener, spike, screw, or nail and extends downward along an outside edge of the shaft for a pre-determined distance, depending on the length of the shaft and the medium into which it is expected to be driven. An exemplary distance for the key way may be approximately one third the length of the shaft of the fastener, spike, screw or nail. The bottom edge of the key way has an outward taper. The cross sectional shape of the key way may be slightly to severely rectangular, oval, elliptical, or the like, but it could be round or square. The key way preferably has a shape that provides directional orientation to the second piece of the invention that fits into the key way. It is to be appreciated that a round or square shape may not provide this orientation.

The second piece of the invention is a separate directional nail or shaft (“key”) that fits into the key way. The key may be provided having any of a number of different cross-sectional shapes, so long as the shape corresponds to that of the key way in the main shaft. It is preferred that the key and key way have a rectangular cross section, but they may alternatively be oval, elliptical, or the like. Such shapes make the key directional, so that it only fits into the key way when properly oriented. The key is longer than the key way so that as it is driven into the key way, the bottom portion is bent out by the bottom tapered edge of the key way, so that it protrudes out into the medium into which the main shaft has been driven. The key includes at least one, although preferably a pair, of raised areas (“friction wedges”) which, when driven (hammered) into the shaft, cut one or more grooves into the key way causing a wedging effect which has dynamic holding ability. The friction wedges can be of any suitable shape, size and number, and can be placed in any location on the area of the key that comes into contact with the key way. The wedges are preferably provided in the form of a pair of elongated ridges located on opposite sides of the key, extending down a short distance below the head of the key. The friction wedges are positioned so that when the key is properly oriented into the key way, the friction wedges make contact with the sides of the key way. The relatively short length of the friction wedges allows most of the body of the key to be more easily driven into the key way before the friction wedges which require more force. As the final section of the key, including the friction wedges, is driven into the key way the wedges cut grooves into the key way that lock the key into place.

The head of the key is large (although not as large as the head of the main spike) for driving and removal purposes. The key head may be shaped so that it fits flush into the chamfered edge of the key way opening of the main spike. However, it is preferred that the key head be provided with one or more stops which when driven into the key way, make contact with the head of the main fastener, spike, screw or nail of the system. In this preferred configuration, the stops are located underneath and on opposite sides of the head of the key, and one or more tapered areas are provided on the sides, preferably at right angles to the stops. The tapered areas slope downward from the underside of the head to the top of the friction wedges. The stops prevent the head from being driven flush against the head of the main spike. The tapered areas leave openings on either side of the key head that allow for the insertion of manual or automated tools for easy removal of the key from the key way.

The key is preferably tapered at the bottom in conformity with the taper in the key way itself. The downward driving process of the key into the key way causes grooves to be cut into the sides of the key way by the friction wedges, and causes the lower portion of the key to bend and project outward at the bottom taper of the key way, away from the main spike or shaft and into the wooden tie or other medium into which the main shaft of the fastener, spike, screw or nail system has already been firmly installed. This angled insertion into the wooden tie or other medium provides greater stability to the main spike or shaft of the fastener, spike, screw or nail system, since it provides more than just the downward angle of connection that the main spike or shaft of the fastener, spike, screw or nail system would otherwise provide.

Provided at the bottom of the key shaft, are tapers which are located on both sides of the key, opposite to the sides having the friction wedges. The tapers preferably angle downward to a blunt end opposite the head. The blunt end is designed to cut fibers while being driven into a wooden cross tie or other appropriate medium. The blunt end of the key may also be used as a tool to clear the key way, which is accomplished by driving a key downward into the key way.

The spike or shaft of the main fastener, spike, screw or nail system is first driven into the tie or selected medium. Once it is firmly in place, the directional key is oriented and then inserted into the key way and driven downward, such that the friction wedges on the key self-cut along the sides of the key way, which creates a stronger wedging effect that withstands heavy pressures and vibrations. This driving process causes the lower portion of the key to be bent outward at an angle away from the main spike or shaft of the fastener, spike, screw or nail system and into the medium into which the main spike or shaft of the spike, nail or screw system has already been installed. This angled insertion into the medium provides greater stability to the main spike or shaft, since it provides more than just the downward taper of connection that the main spike or shaft would otherwise provide. Furthermore, when the fastener, spike, screw or nail system of the present invention is installed, strong vibrations or weathering is less likely to dislodge the key, due to the metallic binding from the grooves made in the key way by the self-cutting of the friction wedges. This creates strong, long-lasting holding ability, which locks and holds the key in place thus restricting the ability of the key to become dislodged from the key way.

Once the key is completely driven into the key way, the stops on the head of the key make contact with the top of the head of the main spike or shaft. This leaves the tapered areas on the sides of the key head of the key exposed for easy removal of the key from the key way either manually or by automated equipment.

In an alternative embodiment, a metallic member such as a tie plate is also provided with or on the medium. A typical railroad tie plate supports the rails and provides an interface between the rails above and the wooden tie below. The tie plate includes a plurality of openings through which the first large shafts or spikes of the present invention may be driven. Then, when the smaller shaft is driven into the key way of such shafts, there is frictional connectivity (interlocking action) between the key, main shaft and the tie plate. This further strengthens the connection made.

It is to be appreciated that the length of the key way, the length of the key, the length of the friction wedges and the length of the bottom tapers of the key may all be varied and provided in different combinations. In one aspect, these lengths may be established so that the tapered end of the key begins to bend and protrude into the medium just as the friction wedges make contact with the sides of the key way. In another aspect, the key may be so long that the end of the key is already protruding well into the medium by the time the friction wedges begin to cut into the key way. Numerous other aspects and combinations may be utilized depending upon the desires of the user.

### BRIEF DESCRIPTION OF THE DRAWINGS

FIG. 1A is a front view of a modified railroad spike version of the present invention showing the large first shaft and head with the key way along the back.

FIG. 1B is a back view of the modified railroad spike version of the present shown in FIG. 1A.

FIG. 1C is a side view of the modified railroad spike version of the present shown in FIG. 1A.

FIG. 2 is a top view of the embodiment shown in FIG. 1 with head, chamfer and key way.

FIG. 3A is a perspective view of the embodiment of FIG. 1 showing the chamfer, key way and taper before grooves have been self-cut into the key way by the friction wedges on the key.

FIG. 3B is a perspective view of the embodiment of FIG. 1 illustrating the orientation of the key with respect to the key way of the main spike before being driven into the key way.

FIG. 4A is a perspective view of the embodiment of FIG. 1 showing the chamfer, key way and taper after grooves have been self-cut into the key way by the friction wedges on the key.

FIG. 4B is a perspective view of the embodiment of FIG. 1 showing the key and key way after the key has been driven into and then removed from the key way.

FIG. 5 is a front view of the key.

FIG. 6 is a side view of the key.

FIG. 7 is a schematic view showing how the embodiment of FIG. 1. fits over the flange of a rail, into a tie plate, and thereafter into the railroad tie itself, and how the key fits into the key way.

FIGS. 8A-8D are a series of sectional side views showing the progressive insertion of a key into the key way of a spike from its initial insertion (8A) to its complete insertion (8D) showing the penetration of the key into the tie.

FIG. 9 is a perspective cross-sectional view of the embodiment of FIG. 1, and an entire key which has been driven into the key way, made contact with the bottom taper of the key way and now projects outward from the key way.

FIG. 10 is an alternative embodiment of the present invention showing a screw type main shaft having a square head with chamfer, and double-headed key with friction wedge.

FIG. 11 is an alternative embodiment of the present invention showing an elongated screw type spike with a round head, dome type hex key center, chamfer and key with friction wedge, such as might be used for holding railroad ties or bridge trusses together.

FIG. 12 is an alternative embodiment of the present invention showing a main shaft having a rounded dome head, chamfer and key with friction wedge such as might be used for a bridge, pier, or dock spike.

FIG. 13 is an alternative embodiment of the present invention showing a flat-headed main shaft with chamfer and key with friction wedge.

### DETAILED DESCRIPTION

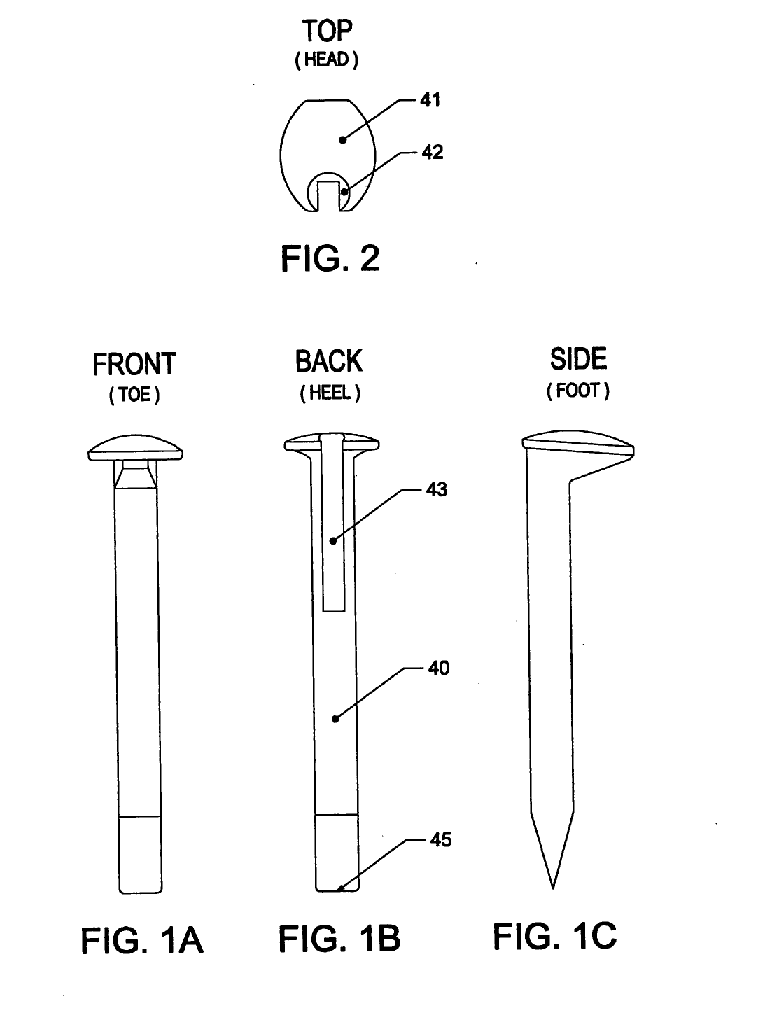

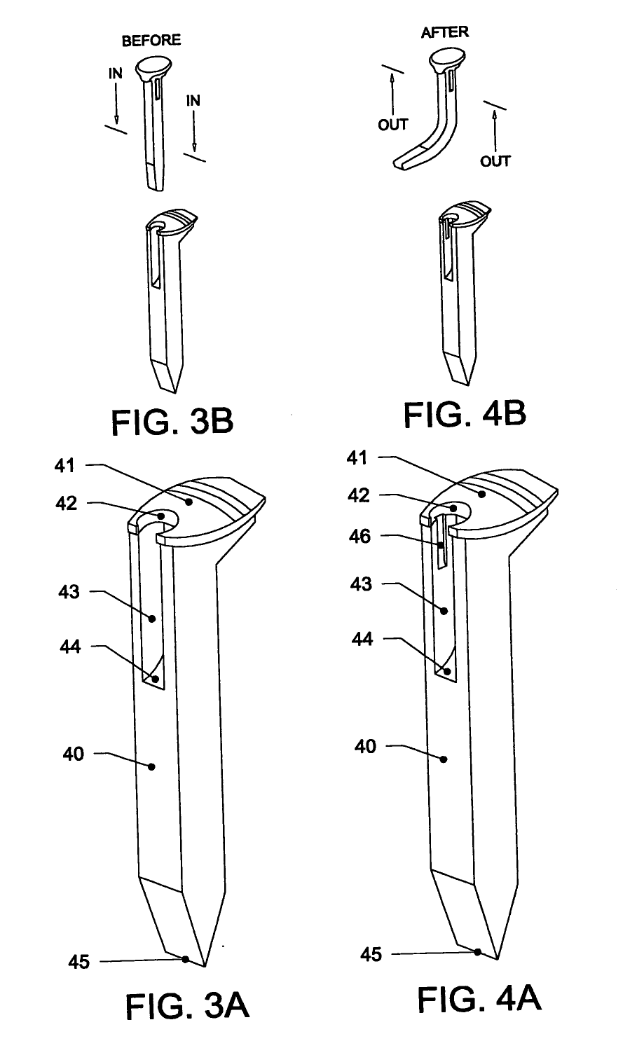

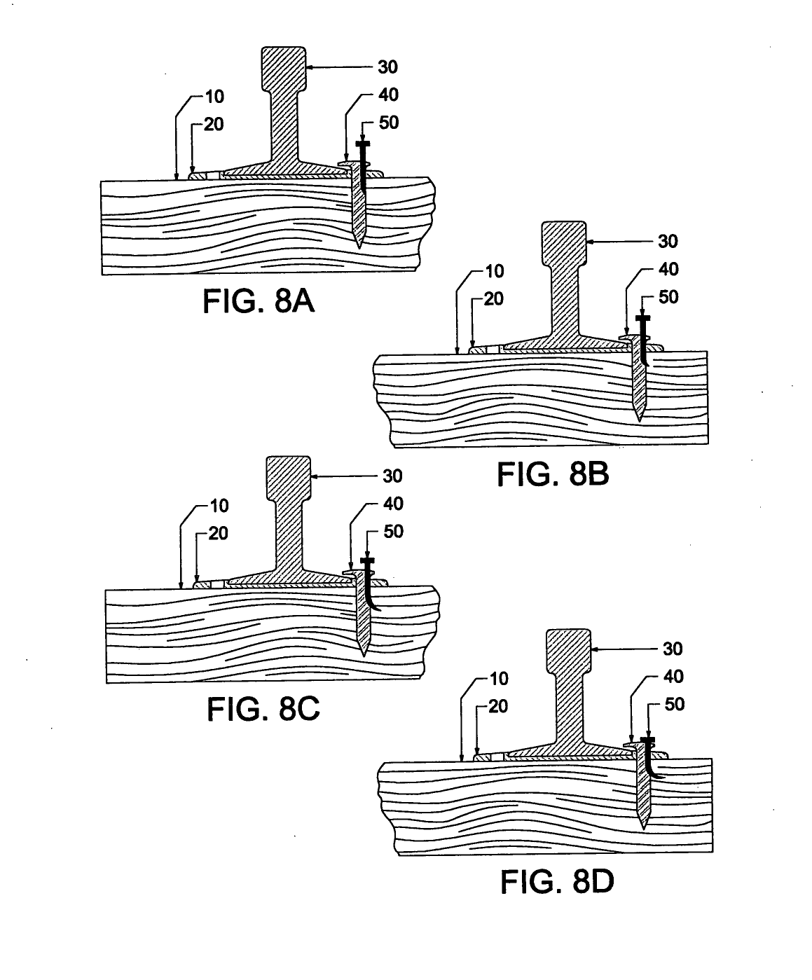

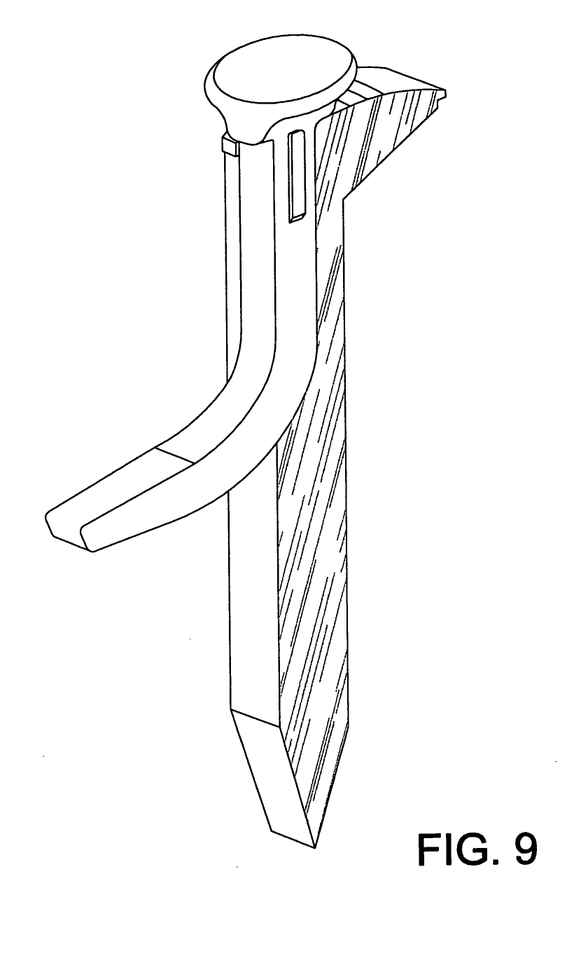

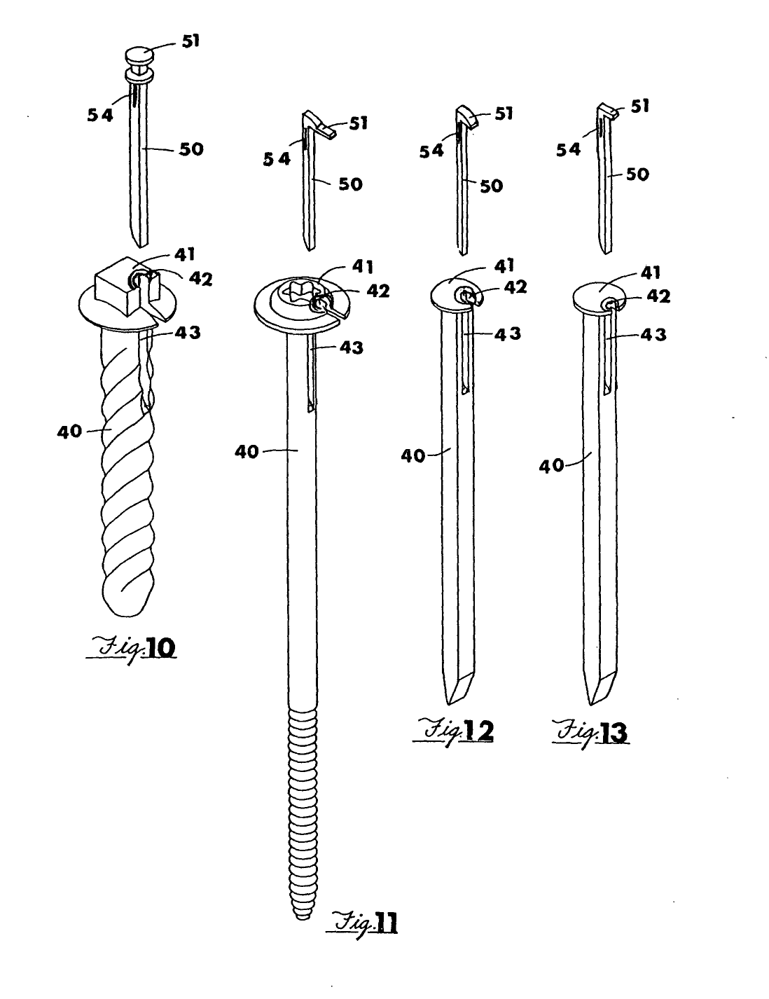

Referring to the drawings wherein like reference characters designate like or corresponding parts throughout the several views, and referring particularly to FIGS. 1-4, it is seen that a railroad spike version of the present invention is illustrated having a square or rectangular shaft 40, with a point 45 at one end and a head 41 at the opposite end. In the railroad spike version, head 41 extends outwardly over one side of the shaft 40 to form a lip, which makes contact with the flange of a rail (FIG. 8). A vertical slot (“key way”) 43 is cut or formed on the side of head 41 opposite the lip, and extends downwardly from the head 41 part way down the length of shaft 40. Key way 43 is tapered outwardly at bottom edge 44 (FIG. 3A). A beveled countersink or guide (“chamfer”) 42 is cut or formed into head 41 around the opening formed by the key way (FIG. 2). Chamfer 42 helps align and guide key 50 into key way 43 for ease of installation, which can be either manual or automated (FIG. 3B). It is to be appreciated that the key way 43 must have a cross sectional shape that allows for directional orientation of the key 50 that is to be inserted therein. This shape may be slightly to severely rectangular, oval, elliptical, or the like (e.g., biaxial), but generally not perfectly round or square—since such shapes would not easily facilitate orientation of the key 50.

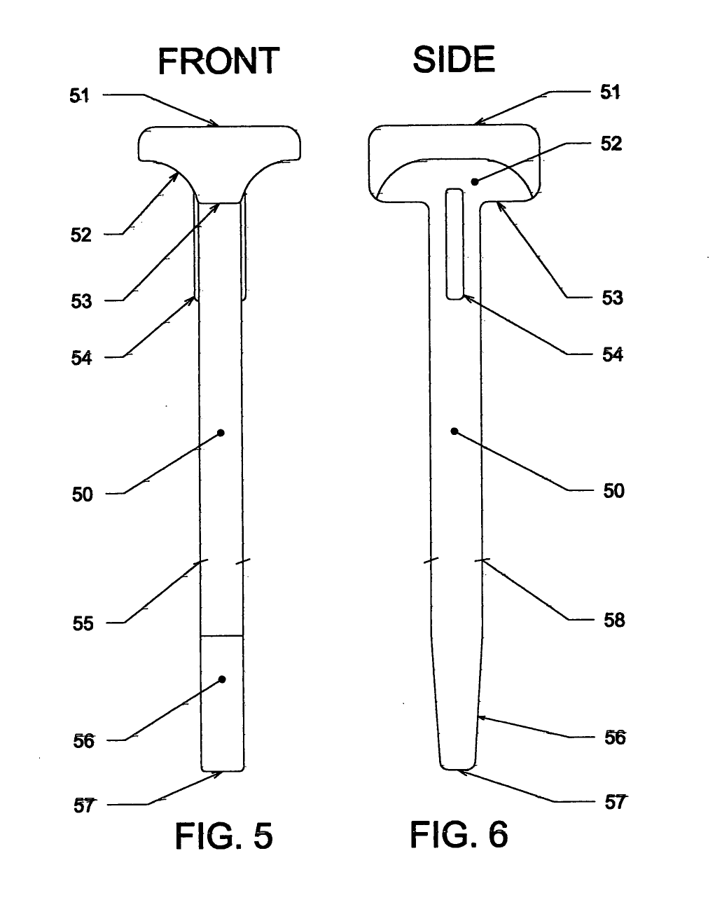

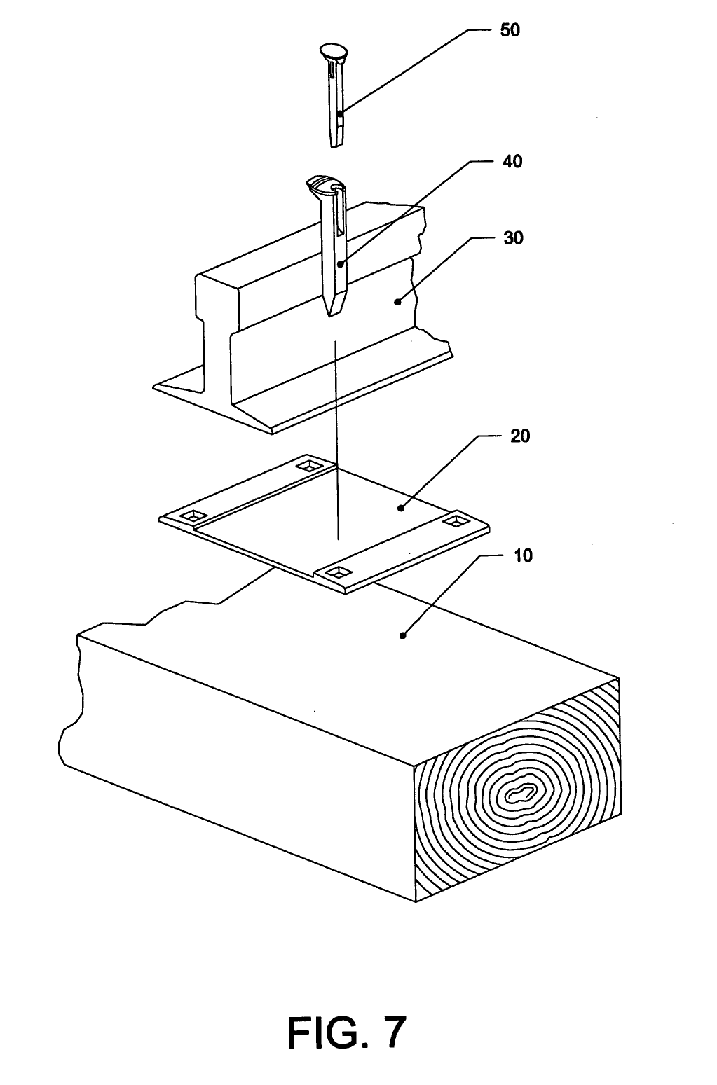

FIGS. 5-6 illustrate a version of the second piece of the present invention. This piece is a separate, directional nail (“key”) 50, which is designed to be inserted and then driven into the key way 43. Key 50 is longer than the key way 43, and has a cross-sectional shape that corresponds to the cross-sectional shape of the key way 43 for directional orientation. Directional key 50 contains one or more raised longitudinal ridges (“friction wedges”) 54, which cut grooves 46 into the sides of key way 43 (FIG. 4) when key 50 is driven therein.

FIG. 7 demonstrates the invention in use over the medium 10, here a wooden railroad tie. A rail 30 is then laid upon the tie plate 20. The shaft 40 is inserted through a hole in the tie plate 20, such that the lip of the shaft 40 engages the rail 30 after being driven downward into the wooden tie 10. The key 50 is now ready to be driven downward into the shaft 40. Key 50 is first positioned above the key way 43 of the spike 40 so that chamfer 42 aligns and guides key 50 into key way 43. The cross sectional shape of the key 50 and corresponding shape of key way 43 will only allow key 50 to be inserted into key way 43 when properly oriented. This may require rotating the key before insertion. Doing so also aligns one of angles 56 of key 50 with angle 44 of key way 43 so that the two angles will come into contact with one another at the bottom of key way 43. Key 50 is then driven into key way 43 such that the bottom 57 of key 50 bends at an outward angle from shaft 40 into the medium 10. The longer the length of key 50, the farther it goes into medium 10.

The directional shape of key 50 and key way 43 also assure that the friction wedges 54 of key 50 are properly aligned so that they make contact with one or more of the sides of key way 43. As the friction wedges 54 on key 50 are driven downward into key way 43 they self-cut grooves 46 (FIG. 4) on the sides of key way 43. This provides secure frictional attachment between key 50 and key way 43. When the downward driving of key 50 is complete, the bottoms of stops 53 make contact with the top of head 41 (FIG. 9). The tapers 52, located on the same sides as friction wedges 54, allow for easy removal of key 50 either manually or with automated tools and machinery.

The progression of insertion is illustrated in FIGS. 8A-8D. In FIG. 8A, key 50 has been inserted into the key way of spike or shaft 40. However, key 50 is currently straight because its lower taper 56 has not yet come into contact with bottom taper 44 of key way 43. In FIG. 8B, the two tapers 56 and 44 have contacted, due to the driving of key 50, forcing it to bend in an outward manner from spike 40 into medium 10. In FIG. 8C, this bending process continues then terminates in FIG. 8D when key 50 is fully inserted into spike or shaft 40 and medium 10. This action also has the effect of exerting additional frictional force inside the opening in plate 20, holding shaft 40 and key 50 firmly therein. The results are a stronger connection than would otherwise be available with a simple shafted spike. This improved fastening system is made possible by the unique interaction of the key 50 in the key way 43.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification. Among other things, a key can be used to clear or remove a broken key lodged in the key way. In particular, although many of the illustrations are directed toward an embodiment for use with a railroad spike, tie plate, and tie system, it is to be appreciated that slightly modified versions of the present invention may be utilized in bridge systems, piers, or other support structures made of wood or other similar materials. Specifically, although the bottom 57 of key 50 is shown as tapered 56 on both sides, it is to be appreciated that any number of sides may be tapered in such a manner, or that no tapering may be provided at all. Similarly, although the drawings depict key 50 as directional and rectangular, it is to be appreciated that key 50 may be of any suitable directional shape or size. Similarly, although the drawings depict key 50 with a rectangular shaft, it is to be appreciated that key 50 may have any spike or shaft that corresponds in shape to tapered key way 43. Finally, although two friction wedges 54 are illustrated in the drawings, any suitable number may be used, depending upon the size and shape of the key 50 and key way 43.

1. A locking device comprising:
a. a first elongated shaft having a head at one end, a point at the opposite end, and at least one side between the head and the point;
b. a longitudinal groove in the shaft extending through the head and part way down the side, said groove having a biaxial cross sectional shape, and being outwardly tapered at the end opposite the head; and
c. a second shaft having a cross section corresponding to that of said groove for oriented insertion therein, said second shaft including at least one friction wedge along a portion of its length for frictionally cutting into said groove for secure attachment thereto.

2. The locking device of claim 1 wherein said second shaft is provided with a head.

3. The locking device of claim 2 wherein a beveled countersink is provided in the head of the main shaft around the opening formed by the groove.

4. The locking device of claim 3 wherein at least one stop is provided beneath the head of said second shaft so as to prevent full flush insertion of said second head into said beveled countersink.

5. The locking device of claim 4 wherein at least one tapered area is provided between said stop and said second head to facilitate removal of said second shaft from said groove.

6. The locking device of claim 5 wherein a plate member associated with a medium into which said locking device is driven is provided, said plate member having an opening with the same cross section as the first shaft for receiving this shaft and thereafter becoming frictionally attached thereto from the frictional interaction of the second shaft in the groove.

7. The locking device of claim 5 wherein said first shaft is a modified railroad spike.

8. The locking device of claim 5 wherein said first shaft is a screw-type railroad spike.

9. The locking device of claim 5 wherein said first shaft is an elongated rounded railroad spike having screw threads along the bottom thereof used for holding railroad ties together.

10. The locking device of claim 5 wherein said first shaft has a rounded dome head.

11. The locking device of claim 5 wherein said first shaft has a flat head.

12. The locking device of claim 5 wherein said second shaft is provided with a pair of heads.

13. The locking device of claim 5 wherein said first shaft is a large screw.

14. The locking device of claim 5 wherein said groove is a key way.

15. A two-piece locking fastener comprising a shaft having a head with a chamfered opening leading into a key way which extends from the top of the shaft part way down along a side thereof, said key way having an outward taper at the bottom, and a key which fits into said key way having a tapered blunt end at the bottom which corresponds to the tapered bottom of the key way, said key having at least one friction wedge along a portion of its length for frictionally cutting into said key way for secure attachment thereto, and wherein the cross sectional shape of the key and key way are such that the key must have a predetermined orientation before it can be inserted into the key way.

16. The locking fastener of claim 15 wherein said key is provided with a head.

17. The locking fastener of claim 16 wherein a beveled countersink is provided in the head of the shaft around the opening formed by the key way.

18. The locking fastener of claim 17 wherein at least one stop is provided beneath the head of the key so as to prevent full flush insertion of the key head into said beveled countersink.

19. The locking fastener of claim 18 wherein at least one tapered area is provided between said stop and the key head to facilitate removal of the key from the key way.

20. The locking fastener of claim 19 wherein a plate member is provided that is associated with a medium into which said locking fastener is driven, said plate member having an opening for receiving the shaft and thereafter becoming frictionally attached thereto from the frictional interaction of the key in the key way.

21. A method for securely attaching at least two objects together comprising the steps of:
a. driving a fastener through the first of said objects and into the second of said objects, said fastener comprising a shaft having a head with a chamfered opening leading into a key way which extends from the top of the shaft part way down along a side thereof, said key way having an outward taper at the bottom;
b. inserting a key into the key way of said fastener, said key having a tapered blunt end at the bottom which corresponds to the tapered bottom of the key way and at least one friction wedge along a portion of its length; and
c. driving the key into the key way causing the bottom portion of the key to extend out and into one of said objects at an angle that is different from that of the fastener, and causing at least one friction wedge to cut into the key way for secure attachment thereto.

22. The method of claim 21 wherein the cross sectional shape of the key and key way are such that the key must have a predetermined orientation before it can be inserted into the key way.

23. The method of claim 22 wherein the key is provided with a head.

24. The method of claim 23 wherein a beveled countersink is provided in the head of the shaft around the opening of the key way.

25. The method of claim 24 wherein at least one stop is provided beneath the head of the key so as to prevent full flush insertion of the key head into said beveled countersink.

26. The method of claim 25 wherein at least one tapered area is provided on the side of said stop and below the key head to facilitate removal of the key from the key way.

27. The method of claim 26 wherein said first object is a plate member and said second object is a medium, said plate member having an opening for receiving the shaft and thereafter becoming frictionally attached thereto from the frictional interaction of the key in the key way.

28. The method of claim 27 wherein said fastener is a modified railroad spike.
